(19) United States
(12) Patent Application Publication
(10) Pub. No.: US 2003/0131352 A1
(43) Pub. Date: Jul. 10, 2003

(54) Controlling television viewing content

(75) Inventors: Rabindranath Dutta, Austin, TX (US); Karthikeyan Ramamoorthy, Austin, TX (US)

Correspondence Address: Kelly K. Kordzik, 5400 Renaissance Tower, 1201 Elm Street, Dallas, TX, 75270, US

(73) Assignee: International Business Machines Corporation, Armonk, NY

(21) Appl. No.: 10/042,005

(22) Filed: Jan. 8, 2002

(51) Int. Cl. H04N 5/14; H04N 7/16; G09G 5/00

(52) U.S. Cl. 725/25; 725/135; 345/723

(57) ABSTRACT

A method, system and computer program product for controlling the content of broadcast material. A master unit may be configured to record a broadcast displayed on the master unit. The master unit may be configured to assign a session to the recorded broadcast. A session may refer to a particular instance of the recorded broadcast. The master unit may be configured to receive input as to which subsidiary unit, e.g., television set, is associated with the assigned session. The master unit may be configured to spawn a thread associated with the assigned session. By spawning a thread for each session assigned, multiple sessions may be assigned for a particular broadcast. Thus, a user, e.g., teacher, parent, guardian, viewing the broadcast may be able to edit, e.g., delete, annotate, a particular broadcast for various age groups which may ultimately be transmitted to different subsidiary units viewed by different age groups.

### TECHNICAL FIELD

The present invention relates to the field of parental control over television content, and more particularly to enabling teachers, guardians, parents, etc., the ability to edit, e.g., delete, annotate, television material that may be viewed by children of various ages within a time delay.

### BACKGROUND INFORMATION

It is believed by many Americans that television programs are influential in the lives of our nation's children. More particularly, parents are concerned with the negative influence television has on their children's social and psychological development. As a result, special interest groups continue to lobby for greater government regulation of broadcast content. Legislative solutions to regulate television content have been attempted.

For example, the US Telecommunications Act of 1996 included initiatives for enabling parental control over what is presented via television screens—effectively requiring inclusion of a viewing controller computer chip or “V-chip” within new television sets. The V-chip enables automatic blocking of presentation of certain television programs on the basis of a content rating system provided by broadcasters. Broadcasters and other providers of video programming in the U.S. have been encouraged to transmit or record program content information for detection by the V-chip, and television manufacturers have been required to implement the necessary electronics to respond to this information. When installed on a television or a set-top device such as a cable television signal receiver unit, or a satellite communication receiver unit, the V-chip may allow the viewer to customize their family's program reception to prevent display of certain types of programs.

However, the V-chip completely blocks out the entire program instead of blocking out only certain portions that a parent may deem to be unacceptable for their child(ren). Furthermore, a parent must rely on the current rating system established by the broadcasters, e.g., rating programs from G to R. However, these ratings may not adequately inform the parent as to what exactly will be displayed and/or heard during a program. Furthermore, not all programs are rated. For example, professional wrestling is unrated, however some parents may consider professional wrestling to be a violent activity that young children should not be able to view.

Another problem with the V-chip is that a parent may believe that the material is appropriate for his/her older child and not appropriate for his/her younger child. By blocking out the entire program so that the younger child is prevented from viewing unacceptable material, the older child and parent are prevented from viewing the program.

Furthermore, the V-chip does not allow a parent to edit or annotate the content of the material thereby being able to provide a historic reference or an alternative point of view.

It would therefore be desirable to enable teachers, guardians, parents, etc., the ability to edit, e.g., delete, annotate, television material that may be viewed by children of various ages within a time delay.

### SUMMARY

The problems outlined above may at least in part be solved in some embodiments by a master unit, e.g., a device comprising a processor, a memory unit, a storage unit and a display, configured to enable a user, e.g., teachers, guardians, parents, to edit, e.g., delete, annotate, one or more instances of a broadcast that may be transmitted to one or more subsidiary units, e.g., television sets, that may be viewed by children of different ages.

In one embodiment of the present invention, a method for controlling the content of broadcast material may comprise the step of a master unit receiving a broadcast signal. The master unit may be any type of device that comprises a processor, a memory unit, a storage unit and a display that may function as a television screen. Upon receiving the broadcast signal, the master unit may be configured to display the broadcast on the display of the master unit that may function as a television screen. The master unit may further be configured to record the broadcast in one or more memory buffers where each memory buffer may be associated with a session. A session may refer to a particular instance of the recorded broadcast that may or may not be edited. For example, one instance of the recorded broadcast may refer to a recorded broadcast that may be viewed within a delay by a first age group, e.g., seven year olds, where another instance of the recorded broadcast may refer to a recorded broadcast that may be viewed within a delay by a second age group, e.g., fifteen year olds.

The master unit may then be configured to assign a particular session to a particular recorded broadcast. As stated above, a session may refer to a particular instance of the recorded broadcast. The memory unit may be configured to store each instance of a recorded broadcast in separate memory buffers.

The master unit may then be configured to receive input as to which subsidiary unit, e.g., television set, is associated with the assigned session. A subsidiary unit may refer to a device that receives recorded broadcasts that may be edited from the master unit. The master unit may further be configured to spawn a thread associated with the assigned session. By spawning a thread for each session assigned, multiple sessions may be assigned for a particular broadcast. Subsequently, the master unit may receive input to assign more than one session to the recorded broadcast. Thus, a user, e.g., teacher, parent, guardian, may be able to edit, e.g., delete, annotate, a particular broadcast for various age groups, e.g., seven year olds, fifteen year olds, which may ultimately be transmitted to different subsidiary units viewed by different age groups. A process that may be executed by each thread associated with a particular session is described below. It is noted that the steps described below for each thread may occur in parallel.

A determination may be made by the master unit as to whether the master unit received an input to delete the content currently and/or just displayed. If the master unit has received an input to delete the content currently and/or just displayed, then the master unit may delete a frame of the broadcast. Upon deleting a frame of the broadcast, the master unit may determine whether the master unit received an input to stop deleting the content currently and/or just displayed. If the master unit has not received an input to stop deleting the content currently and/or just displayed, then the master unit continues to delete the content currently and/or just displayed as stated above. If the master unit has received an input to stop deleting the content currently and/or just displayed, then the master unit stops deleting the content currently and/or just displayed. Upon stopping to delete the content currently and/or just displayed, the master unit determines whether the master unit received an input to delete the content currently and/or just displayed.

If the master unit did not receive an input to delete the content currently and/or just displayed, then the master unit may be configured to determine whether the master unit received an input to annotate the recorded broadcast. If the master unit has received an input to annotate the recorded broadcast, then the master unit may annotate broadcast. Upon annotating the broadcast, the master unit may determine whether the master unit received an input to stop annotating the recorded broadcast. If the master unit has not received an input to stop annotating the recorded broadcast, then the master unit continues to annotate the content as stated above. If the master unit has received an input to stop annotating the recorded broadcast, then the master unit stops annotating the recorded broadcast. Upon stopping to annotate the recorded broadcast, the master unit determines whether the master unit received an input to delete the content currently and/or just displayed.

If the master unit did not receive an input to annotate the recorded broadcast, then the master unit may be configured to determine whether the master unit received an input to delete the content currently and/or just displayed.

As stated above, the process described above may refer to the process executed by each thread associated with a particular session. Subsequently, the steps described above for each thread may occur in parallel. That is, a user, e.g., teacher, parent, guardian, may edit a particular broadcast in multiple sessions concurrently where the edited broadcast in each session may be transmitted to a particular subsidiary unit viewed by different age groups within a time delay.

Upon a time delay which may be variable, the master unit may transmit the recorded broadcast stored in a memory buffer which may be edited, e.g., frames may be deleted, verbal annotations may be interposed on the recorded broadcast, to the appropriate subsidiary unit associated with the memory buffer. For example, as each frame is recorded by the master unit without any edits to the frame, the frame may be saved in a particular buffer that may then be transmitted to the appropriate one or more subsidiary units within a particular delay, e.g., 2 seconds. Furthermore, if the frame has been annotated, the annotated frame may be saved in a particular buffer that may then be transmitted to the appropriate one or more subsidiary units within a particular delay, e.g., 2 seconds. However, if one or more frames have been deleted, then there may be a greater delay, e.g., 10 seconds, in the transmission of frame(s) to one or more subsidiary units until there are frames with content to be transmitted. Hence, the edited broadcast may be transmitted to one or more subsidiary units with a variable delay.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a home network configured in accordance with the present invention;

FIG. 2 illustrates an embodiment of the present invention of a master unit in a network system;

FIG. 3 illustrates a broadcast distribution network configured in accordance with the present invention;

FIG. 4 is a flowchart of a method for controlling the content of broadcast material;

FIG. 5 illustrates an embodiment of memory buffers configured in accordance with the present invention;

FIG. 6 illustrates an embodiment of a remote control configured to input a user's commands to the master unit in accordance with the present invention;

FIG. 7 is a diagram illustrating the flow of broadcast information from a transmitter to the master unit and then to a subsidiary unit in accordance with the present invention;

FIG. 8 is a flowchart of a method for a master unit receiving a broadcast and transmitting the broadcast which may be edited to a subsidiary unit; and

FIG. 9 is a flowchart of a method for a subsidiary unit to receive and display a broadcast, which may be edited, transmitted from the master unit.

### DETAILED DESCRIPTION

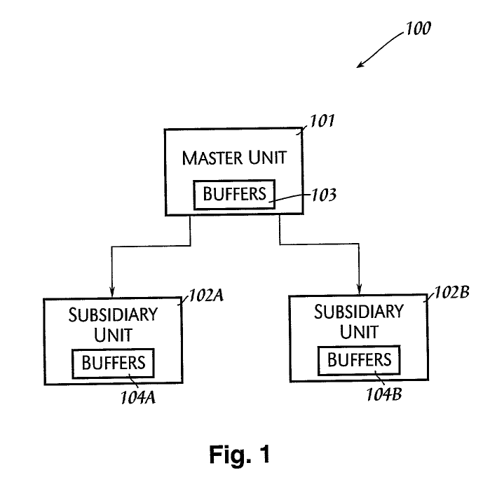

FIG. 1—Home Network

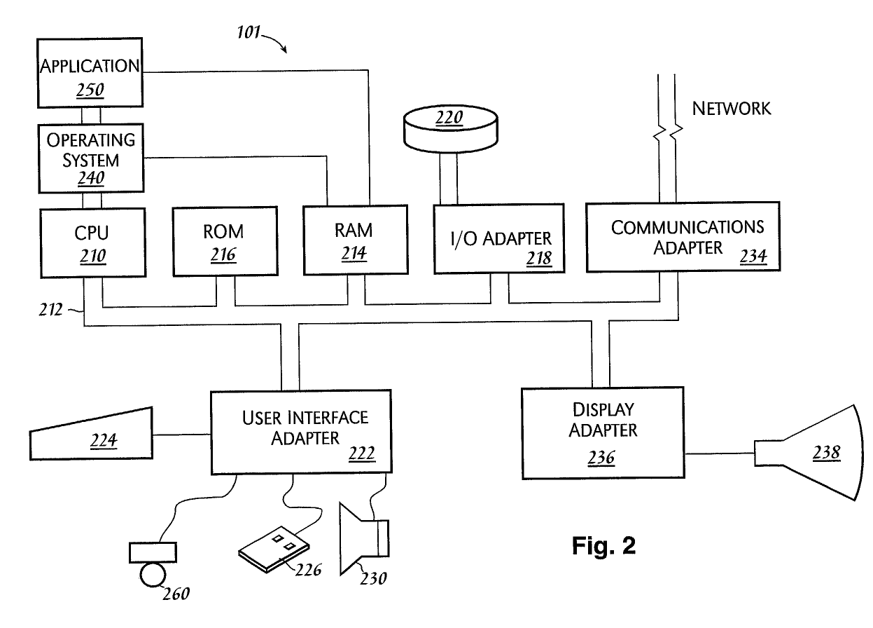

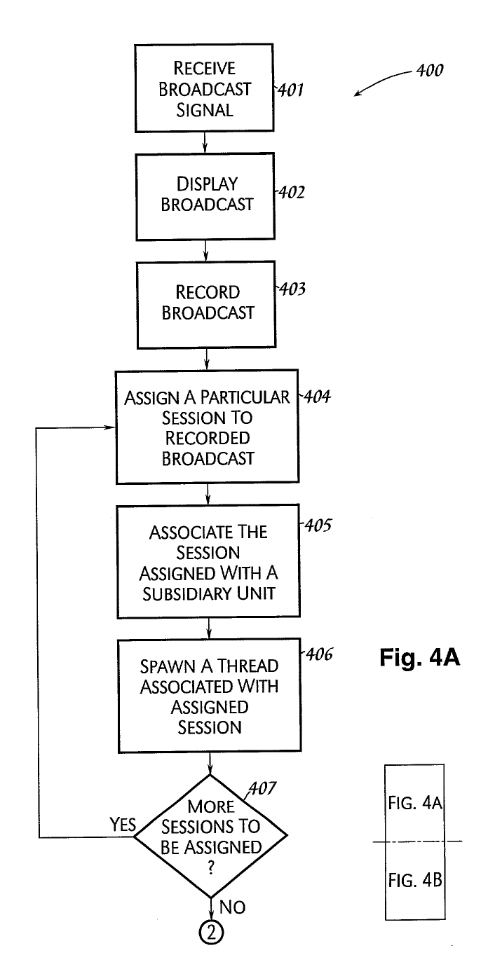

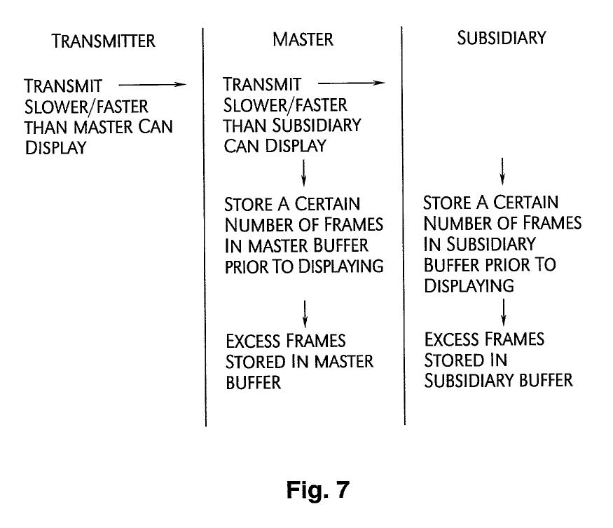

FIG. 1 illustrates an embodiment of the present invention of a home network 100. Home network 100 may comprise a master unit 101 connected to one or more subsidiary units, e.g., subsidiary units 102A-B. Master unit 101 may be a computer configured to display television programs as illustrated in FIG. 2. Master unit 101 may comprise buffers 103 within memory, e.g., RAM, configured to store frames of a transmitted broadcast as well as frames, which may be edited, to be transmitted to one or more subsidiary units, e.g., subsidiary units 102A-B, as explained in greater detail in conjunction with the description of FIGS. 4-9. It is noted that master unit 101 may be any type of device that comprises a processor, a memory unit, a storage unit and a display that may function as a television screen. Master unit 101 may be further configured to allow a user, e.g., parent, guardian, teacher, the ability to edit, e.g., delete, annotate, a broadcast as described in greater detail in conjunction with FIG. 4. Subsidiary units 102A and 102B may include buffers 104A and 104B, respectively, configured to store the frames transmitted by master unit 101, as explained in greater detail in conjunction with the description of FIGS. 7-9.

Subsidiary units 102A-B may collectively or individually be referred to as subsidiary units 102 or subsidiary unit 102, respectively. Buffers 104A-B in subsidiary units 102 may collectively or individually be referred as buffers 104 or buffer 104, respectively.

Subsidiary units 102 may be a device, e.g., television set, that has the ability to display edited broadcasts transmitted from master unit 101. It is noted that the connection between master unit 101 and subsidiary unit 102 may be any medium type, e.g., wireless, wired. It is further noted that home network 100 may comprise any number of subsidiary units 102 and that FIG. 1 is illustrative. It is further noted that home network 100 may be any type of system that has at least one master unit 101 and at least one subsidiary unit 102 and that FIG. 1 is not to be limited in scope to any one particular embodiment.

FIG. 2—Master Unit

FIG. 2 illustrates a typical hardware configuration of master unit 101 which is representative of a hardware environment for practicing the present invention. Master unit 101 may have a central processing unit (CPU) 210 coupled to various other components by system bus 212. An operating system 240, runs on CPU 210 and provides control and coordinates the function of the various components of FIG. 2. Application 250 runs in conjunction with operating system 240 and provides output calls to operating system 240 which implements the various functions to be performed by the application 250. Application 250 may include for example, a program for enabling teachers, guardians, parents, etc., the ability to edit television material that may be viewed by children of various ages within a time delay as described in FIG. 4, a program for interposing a user's verbal annotations onto a recorded broadcast as described in FIG. 4. Read only memory (ROM) 216 is coupled to system bus 212 and includes a basic input/output system (“BIOS”) that controls certain basic functions of master unit 101. Random access memory (RAM) 214, I/O adapter 218, and communications adapter 234 are also coupled to system bus 212. It should be noted that software components including operating system 240 and application 250 are loaded into RAM 214 which is the master unit's 101 main memory. It is further noted that RAM 214 may comprise buffers 103 configured to store frames of a transmitted broadcast as well as frames, which may be edited, to be transmitted to one or more subsidiary units 102 as explained in greater detail in conjunction with the description of FIGS. 4-9. I/O adapter 218 may be a small computer system interface (“SCSI”) adapter that communicates with disk unit 220, e.g., disk drive. It is further noted that master unit 101 may comprise a television tuner card (not shown) coupled to bus 212 configured to receive television broadcast signals. It is further noted that master unit 101 may comprise a cable television converter (not shown) coupled to bus 212 configured to receive television broadcast signals. It is further noted that the program of the present invention that enables teachers, guardians, parents, etc., the ability to edit, e.g., delete, annotate, broadcast material that may be viewed by children of various ages within a time delay as described in FIG. 4 may reside in disk unit 220 or in application 250. It is further noted that the program of the present invention that interposes the user's verbal annotations onto a recorded broadcast as described in FIG. 4 may reside in disk unit 220 or in application 250.

Communications adapter 234 interconnects bus 212 with an outside network such as a Local Area Network (LAN), e.g., Ethernet, Token Ring, ARCnet, or a Wide Area Network (WAN), e.g., Internet. Input/Output devices may also be connected to system bus 212 via a user interface adapter 222 and a display adapter 236. Keyboard 224, mouse 226, speaker 230 and microphone 260 may be interconnected to bus 212 through user interface adapter 222. Event data may be inputted to master unit 101 through any of these devices. For example, microphone 260 may be configured to receive a user's verbal annotation of the broadcast displayed on display 238 by master unit 101 which may then be interposed onto a recorded broadcast. A display monitor 238 may be connected to system bus 212 by display adapter 236. In one embodiment, display monitor 238 may function as a television screen. In this manner, a user may be capable of inputting to master unit 101 through keyboard 224, mouse 226 or microphone 260 and receiving output from master unit 101 via display 238 or speaker 230.

Implementations of the invention include implementations as a computer system programmed to execute the method or methods described herein, and as a computer program product. According to the computer system implementations, sets of instructions for executing the method or methods are resident in the random access memory 214 of one or more computer systems configured generally as described above. Until required by master unit 101, the set of instructions may be stored as a computer program product in another computer memory, for example, in disk drive 220 (which may include a removable memory such as an optical disk or floppy disk for eventual use in disk drive 220). Furthermore, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

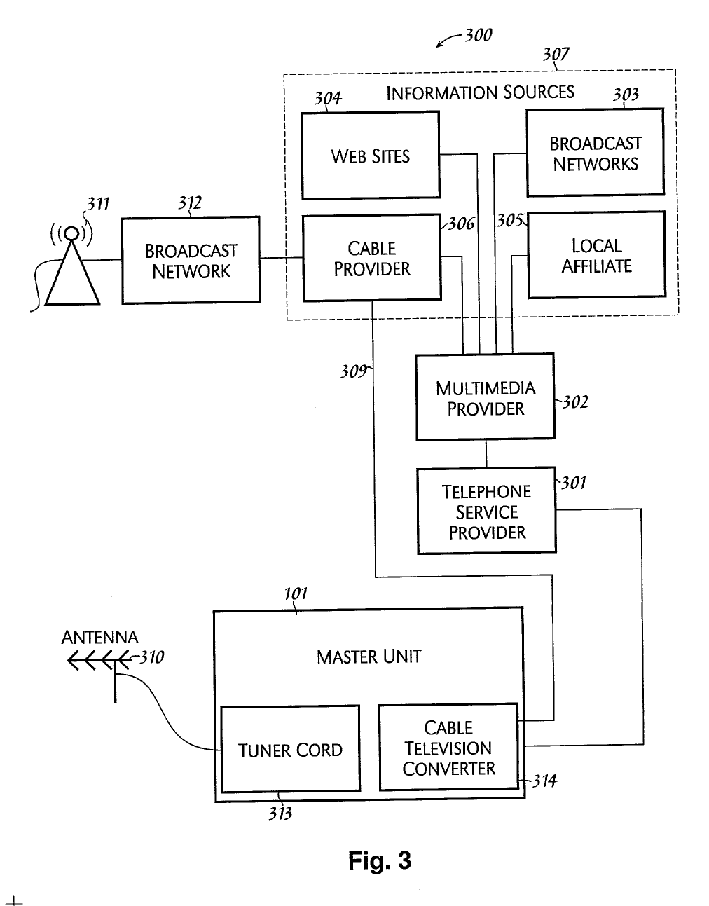

FIG. 3—Broadcast Distribution Network

FIG. 3 illustrates an embodiment of a broadcast distribution network 300 in accordance with the present invention. Master unit 101 may be coupled to a telephone service provider 301 and thereby access broadcast signals from information sources 307, e.g., broadcast networks 303, web sites 304, local affiliate 305, cable provider 306, via a multimedia provider 302. In other embodiments, master unit 101 may access multimedia provider 302 over other communications links, bypassing local communication service providers. Faster communication links such as fiber optics, coaxial cable or radio frequency (wireless) links such as a cellular telephone would provide an equally acceptable communication link for the present invention. One skilled in the art may appreciate the many different communication links which may be utilized to provide the communication path discussed herein and the communication links discussed herein should not be construed in a limited manner.

Master unit 101 may further be configured to receive broadcast signals directly from cable provider 306 or broadcast network 312. Typically, a local cable provider 306 receives a signal from a broadcast network 312 and may distribute the signal to a residential dwelling having a cable television converter 314 via a hardwired cable 309. In this manner, master unit 101 may receive broadcast signals from cable provider 306. Master unit 101 may further receive broadcast signals from broadcast network 312 by a television tuner card 313 receiving broadcast signals through an antenna system depicted by broadcast antenna 311 and receiver antenna 310. It is noted that master unit 101 may be configured to receive broadcast signals using other means, e.g., direct broadcast satellite, and that FIG. 3 is illustrative. It is further noted that other means for receiving broadcast signals would be recognized by an artisan of ordinary skill in the art and that such embodiments employing such means would fall within the scope of the present invention.

The development of computerized information distribution and interconnected computers allow users to link with other computer networks, and retrieve vast amounts of electronic information heretofore unavailable in an electronic medium. Such electronic information increasingly displaces more conventional techniques of information transmission, such as newspapers and magazines. The term “Internet” is an abbreviation for “Internetwork,” and commonly refers to a collection of computer networks interconnected over communication links that utilize standard protocols well-known in the art of computer networking.

A basic computer Internetwork utilizes a client/server architecture. A “client” may refer to a computer that accesses shared network resources provided by another computer commonly referred to as a server.

A “server” may typically be a remote computer system accessible over a communications medium such as the Internet. The server may scan and search for information sources. Based upon information requested by the user, the server may provide video transmission to the user. Referring to FIGS. 1 and 3, master unit 101 may be a client which is capable of receiving information such as broadcast signals. Broadcast signals may be provided by broadcast networks 303, web sites 304, local affiliates 305 and local cable provider 306. However, as would be recognized by those of ordinary skill, the principles of the present invention as discussed hereinbelow are not restricted by a particular signal source.

FIG. 4—Method for Controlling Broadcast Material

FIG. 4 illustrates a flowchart of one embodiment of the present invention of a method 400 for enabling teachers, guardians, parents, etc., the ability to edit, e.g., delete, annotate, broadcast material that may be viewed by children of various ages within a time delay. As stated in the Background Information section, the V-chip completely blocks out the entire program instead of blocking out only certain portions that a parent may deem to be unacceptable for their child(ren). Furthermore, a parent must rely on the current rating system established by the broadcasters, e.g., rating programs from G to R. However, these ratings may not adequately inform the parent as to what exactly will be displayed and/or heard during a program. Furthermore, not all programs are rated. For example, professional wrestling is unrated, however some parents may consider professional wrestling to be a violent activity that young children should not be able to view. Another problem with the V-chip is that a parent may believe that the material is appropriate for his/her older child and not appropriate for his/her younger child. By blocking out the entire program so that the younger child is prevented from viewing unacceptable material, the older child and parent are prevented from viewing the program. Furthermore, the V-chip does not allow a parent to edit or annotate the content of the material thereby being able to provide a historic reference or an alternative point of view. It would therefore be desirable to enable teachers, guardians, parents, etc., the ability to edit, e.g., delete, annotate, broadcast material that may be viewed by children of various ages within a time delay. Method 400 is a method for enabling teachers, guardians, parents, etc., the ability to edit, e.g., delete, annotate, broadcast material that may be viewed by children of various ages within a time delay.

In step 401, master unit 101 may receive a broadcast signal. As stated above, referring to FIG. 3, master unit 101 may be configured to receive a broadcast signal from a broadcast network 312 by a television tuner card 313 receiving the broadcast signal through an antenna system depicted by broadcast antenna 311 and receiver antenna 310. Master unit 101 may further be configured to receive a broadcast signal from cable provider 306 by cable television converter 314 receiving the broadcast signal though hardwired cable 309. Master unit 101 may further be configured to receive a broadcast signal from multimedia provider 302 via telephone service provider 301. Multimedia provider 302 may be configured to provide broadcast signals from a variety of information sources 307, e.g., broadcast networks 303, web sites 304, local affiliate 305, cable provider 306. It is noted that master unit 101 may be configured to receive broadcast signals using other means recognized by an artisan of ordinary skill in the art and that such embodiments employing such means would fall within the scope of the present invention.

In step 402, master unit 101 may display the broadcast signal on display 238. In one embodiment, display monitor 238 may function as a television screen.

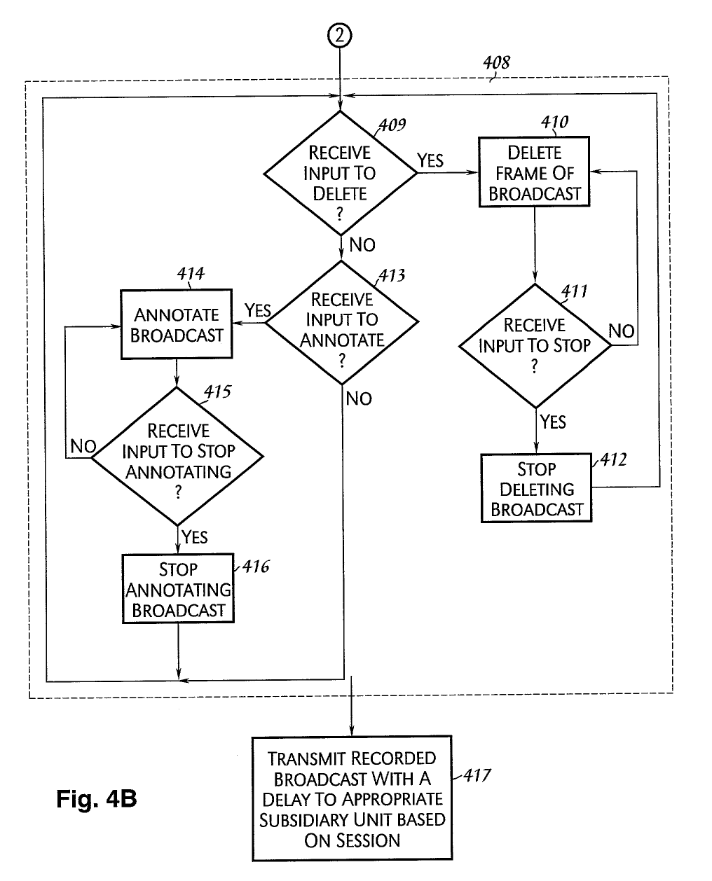

In step 403, master unit 101 may record the broadcast. In one embodiment, master unit 101 may be configured to store the broadcast signal in one or more buffers 103 stored in memory, e.g., memory 214, as illustrated in FIG. 5. FIG. 5 illustrates an embodiment of the present invention of buffers 103, e.g., buffers 103A-C. Buffers 103A-C may collectively or individually be referred to as buffers 103 or buffer 103, respectively. It is noted that buffer 104 may be similarly configured as buffer 103.

Each buffer 103 may be configured to store information, e.g., audio and video information of the broadcast, verbal annotations of the user, associated with a particular session as described in greater detail further below. A session may refer to a particular instance of the recorded broadcast that may or may not be edited. For example, one instance of the recorded broadcast may refer to a recorded broadcast that may be viewed with a delay by a first age group, e.g., seven year olds, where another instance of the recorded broadcast may refer to a recorded broadcast that may be viewed with a delay by a second age group, e.g., eleven year olds, as discussed in greater detail below.

FIG. 5 illustrates an embodiment of the present invention of buffer 103 configured to store frames of video and audio information of the broadcast signal as well as annotations provided by the user. Each buffer 103 may comprise a plurality of units of editing 501A-H where each unit may store one or more frames of video and audio information from the broadcast signal as well as annotations provided by the user. Units of editing 501A-H may collectively or individually be referred to as units of editing 501 or unit of editing 501, respectively. It is noted that the memory, e.g., memory 214, of master unit 101 may store any number of buffers associated with any number of sessions and that FIG. 5 is illustrative. It is further noted that buffer 103 may comprise any number of units 501 for storing frames.

Returning to FIG. 4, in step 404, master unit 101 may assign a particular session to the recorded broadcast in response to an input from a user viewing the broadcast on master unit 101. As stated above, a session may refer to a particular instance of the recorded broadcast. Master unit 101 may be configured to store each instance of a recorded broadcast in separate buffers, e.g., buffers 103A-C, in memory, e.g., memory 214.

Referring to FIG. 5, memory buffer 103A associated with session #1 may store frames n, o, p, q, r, s, t and u of the broadcast. Memory buffer 103B associated with session #2 may record the same video and audio information of the broadcast signal as in session #1 except that the user deleted frame ‘p’ of the broadcast signal for session #2. Memory buffer 103C associated with session #2 may record frame ‘n’ of the broadcast signal followed by storing annotations provided by the user in the succeeding units 501 of memory buffer 103C as indicated by “A′”. A detail description describing the user deleting frame(s) of the broadcast signal and/or providing annotations to the broadcast is further provided below.

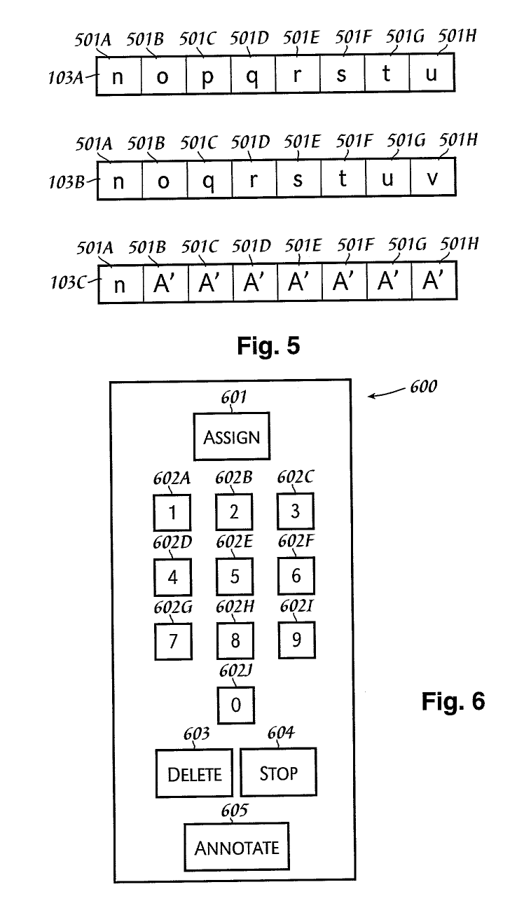

As stated above, master unit 101 may assign a particular session to the recorded broadcast in response to an input from a user viewing the broadcast on master unit 101. A user may select a button on a remote control to indicate to memory unit 101 to assign a particular session, as illustrated in FIG. 6. FIG. 6 illustrates an embodiment of the present invention of a remote control 600 with a plurality of buttons 601-605 configured to indicate certain commands, e.g., assign session, to master unit 101. For example, a user may select assign button 601 to indicate to master unit 101 to assign a particular session to the broadcast recorded in step 403. It is noted that there are other means of indicating to master unit 101 to assign a particular session. It is further noted that those other means would be recognized by an artisan of ordinary skill in the art and that such embodiments employing such means would fall within the scope of the present invention. It is further noted that remote control 600 may comprise any number of buttons configured to indicate any number of commands to master unit 101 and that FIG. 6 is illustrative.

Returning to FIG. 4, in step 405, master unit 101 may be configured to associate the session assigned in step 404 with a subsidiary unit 102 in response to an input from a user viewing the broadcast on master unit 101 by selecting one or more buttons on a remote control, as illustrated in FIG. 6. Referring to FIG. 6, a user may select one or more numeric buttons, e.g., buttons 602A-J, to select a subsidiary unit 102 associated with the session assigned in step 404. It is noted that there are other means of indicating to master unit 101 which subsidiary unit 102 is associated with the session assigned in step 404. It is further noted that those other means would be recognized by an artisan of ordinary skill in the art and that such embodiments employing such means would fall within the scope of the present invention.

The subsidiary unit 102, e.g., subsidiary unit 102A, associated with the session assigned in step 404 may receive the recorded broadcast, which may be edited, at a later point in time. For example, a user, e.g., teacher, parent, guardian, may edit the recorded broadcast which may then be transmitted, i.e., the edited recorded broadcast may be transmitted, by master unit 101 to a particular subsidiary unit 102, e.g., subsidiary unit 102A, at a later point in time. The edited recorded broadcast may then be viewed by a particular age group, e.g., seven year olds, viewing the particular subsidiary unit 102, e.g., subsidiary unit 102A.

In step 406, master unit 101 may spawn a thread associated with the session assigned in step 404. By spawning a thread for each session assigned, multiple sessions may be assigned for a particular broadcast. Thus, a user, e.g., teacher, parent, guardian, may be able to edit a particular broadcast for various age groups, e.g., seven year olds, fifteen year olds, which may ultimately be transmitted to different subsidiary units 102, e.g., subsidiary unit 102A viewed by seven year olds, subsidiary unit 102B viewed by fifteen year olds. A more detailed description of editing the recorded broadcast for different sessions is provided further below.

In step 407, a determination may be made by master unit 101 as to whether there are more sessions to be assigned. Referring to FIG. 6, in one embodiment, a user may indicate to master unit 101 that there are more sessions to be assigned by selecting assign button 601. Upon master unit 101 determining that another session needs to be assigned, master unit 101 may assign another particular session to the recorded broadcast in step 404.

If master unit 101 determines that no more sessions need to be assigned, then method 400 proceeds to subprocess 408. In one embodiment, master unit 101 may determine that there are no more sessions to be assigned by not receiving any input from user indicating to assign another session. Referring to FIG. 4, subprocess 408 may refer to the process executed by each thread associated with a particular session. It is noted that the steps of subprocess 408 for each thread may occur in parallel.

Referring to subprocess 408, master unit 101 may be configured to determine if master unit 101 has received an input from a user, e.g., teacher, parent, guardian, viewing the program on display 238 to delete the content currently and/or just displayed in step 409.

If master unit 101 has received an input from a user, e.g., teacher, parent, guardian, viewing the program on display 238 to delete the content currently and/or just displayed then master unit 101 may delete a frame of the broadcast in step 410. For example, the user, e.g., teacher, parent, guardian, may input to master unit 101 an indication to delete a scene that includes sexual content. For example, referring to FIG. 5, a user may input to master unit 101 an indication to delete frame ‘p’ of the broadcast as illustrated in memory buffer 103B associated with session #2. Subsequently, memory buffer 103B does not contain frame ‘p’ of the broadcast. In one embodiment, the user may indicate to master unit 101 to delete the content currently and/or just displayed by selecting a delete button 603. It is noted that there are other means of indicating to master unit 101 to delete the content currently and/or just displayed. It is further noted that those other means would be recognized by an artisan of ordinary skill in the art and that such embodiments employing such means would fall within the scope of the present invention.

Upon deleting a frame of the broadcast currently and/or just displayed in step 410, master unit 101 may be configured to determine if master unit 101 has received an input from a user, e.g., teacher, parent, guardian, viewing the program on display 238 to stop deleting the content currently and/or just displayed in step 411. If master unit 101 has not received an input from the user, e.g., teacher, parent, guardian, viewing the program on display 238 to stop deleting the content currently and/or just displayed then master unit 101 may continue to delete another frame of the broadcast in step 410. If master unit 101 has received an input from the user, e.g., teacher, parent, guardian, viewing the program on display 238 to stop deleting the content currently being displayed then master unit 101 may stop deleting the broadcast in step 412. Master unit 101 may then determine if master unit 101 has received an input from a user, e.g., teacher, parent, guardian, viewing the program on display 238 to delete the content currently and/or just displayed in step 409.

Referring to step 409, if master unit 101 has not received an input from the user, e.g., teacher, parent, guardian, viewing the program on display 238 to delete the content currently and/or just displayed then master unit 101 may determine if master unit 101 has received an input from the user, e.g., teacher, parent, guardian, viewing the program on display 238 to annotate the content of the program displayed on display 238 in step 413.

If master unit 101 has received an input from a user, e.g., teacher, parent, guardian, viewing the program on display 238 to annotate the content currently and/or just displayed then master unit 101 may annotate the broadcast in step 414. For example, the user, e.g., teacher, parent, guardian, may input to master unit 101 an indication to annotate the broadcast currently being displayed, e.g., argument for legalizing euthanasia. The user may desire to annotate the broadcast to provide a historic reference or an alternative point of view, e.g., legalizing euthanasia may result in allowing doctors the right to decide to terminate a life thereby taking the decision away from patients and therefore should not be legal. For example, referring to FIG. 5, a user may input to master unit 101 an indication to annotate frames ‘o-v’ of the broadcast as illustrated in memory buffer 103C associated with session #3. Subsequently, memory buffer 103C contains annotations provided by the users for frames ‘o-v’ of the broadcast. In one embodiment, the user may indicate to master unit 101 to annotate the content currently being displayed by selecting an annotate button 605. It is noted that there are other means of indicating to master unit 101 to annotate the content currently being displayed. It is further noted that those other means would be recognized by an artisan of ordinary skill in the art and that such embodiments employing such means would fall within the scope of the present invention.

Upon receiving an input from the user to annotate the broadcast, master unit 101 may be configured to annotate the broadcast by software configured to interpose the user's verbal annotation received from microphone 260 (FIG. 2) onto the recorded broadcast. It is noted that the software configured to interpose the user's verbal annotation onto the recorded broadcast may reside in application 250 (FIG. 2) or in disk unit 220 (FIG. 2). It is further noted that there are other means of recording verbal annotations onto a recorded broadcast. It is further noted that those other means would be recognized by an artisan of ordinary skill in the art and that such embodiments employing such means would fall within the scope of the present invention.

Upon annotating the broadcast currently being displayed in step 414, master unit 101 may be configured to determine if master unit 101 has received an input from a user, e.g., teacher, parent, guardian, viewing the program on display 238 to stop annotating the content currently being displayed in step 415. If master unit 101 has not received an input from the user, e.g., teacher, parent, guardian, viewing the program on display 238 to stop annotating the content currently being displayed then master unit 101 may continue to annotate the broadcast in step 414. If master unit 101 has received an input from the user, e.g., teacher, parent, guardian, viewing the program on display 238 to stop annotating the broadcast currently being displayed then master unit 101 may stop annotating the broadcast in step 416. Master unit 101 may then determine if master unit 101 has received an input from a user, e.g., teacher, parent, guardian, viewing the program on display 238 to delete the content currently and/or just displayed in step 409.

Referring to step 413, if master unit 101 has not received an input from the user, e.g., teacher, parent, guardian, viewing the program on display 238 to annotate the content currently being displayed then master unit 101 may determine if master unit 101 has received an input from a user, e.g., teacher, parent, guardian, viewing the program on display 238 to delete the content currently and/or just displayed in step 409.

As stated above, subprocess 408 may refer to the process executed by each thread associated with a particular session. Subsequently, the steps of subprocess 408 for each thread may occur in parallel. That is, a user, e.g., teacher, parent, guardian, may edit a particular broadcast in multiple sessions concurrently where the edited broadcast in each session may be transmitted to a particular subsidiary unit 102 viewed by different age groups within a time delay as discussed below.

Upon a time delay which may be variable, master unit 101 may transmit the recorded broadcast stored in memory buffer 103 which may be edited, e.g., frames may be deleted, verbal annotations may be interposed on the recorded broadcast, to the appropriate subsidiary unit 102 associated with memory buffer 103 in step 417. For example, as each frame is recorded by master unit 101 without any edits to the frame, the frame may be saved in a particular buffer 103 that may then be transmitted to the appropriate one or more subsidiary units 102 within a particular delay, e.g., 2 seconds. Furthermore, if the frame has been annotated, the annotated frame may be saved in a particular buffer 103 that may then be transmitted to the appropriate one or more subsidiary units 102 within a particular delay, e.g., 2 seconds. However, if one or more frames have been deleted, then there may be a greater delay, e.g., 10 seconds, in the transmission of frame(s) to one or more subsidiary units 102 until there are frames with content to be transmitted. Hence, the edited broadcast may be transmitted to one or more subsidiary units 102 with a variable delay.

It is noted that method 400 may be executed in a different order presented and that the order presented in the discussion of FIG. 4 is illustrative. It is further noted that certain steps may be executed almost concurrently.

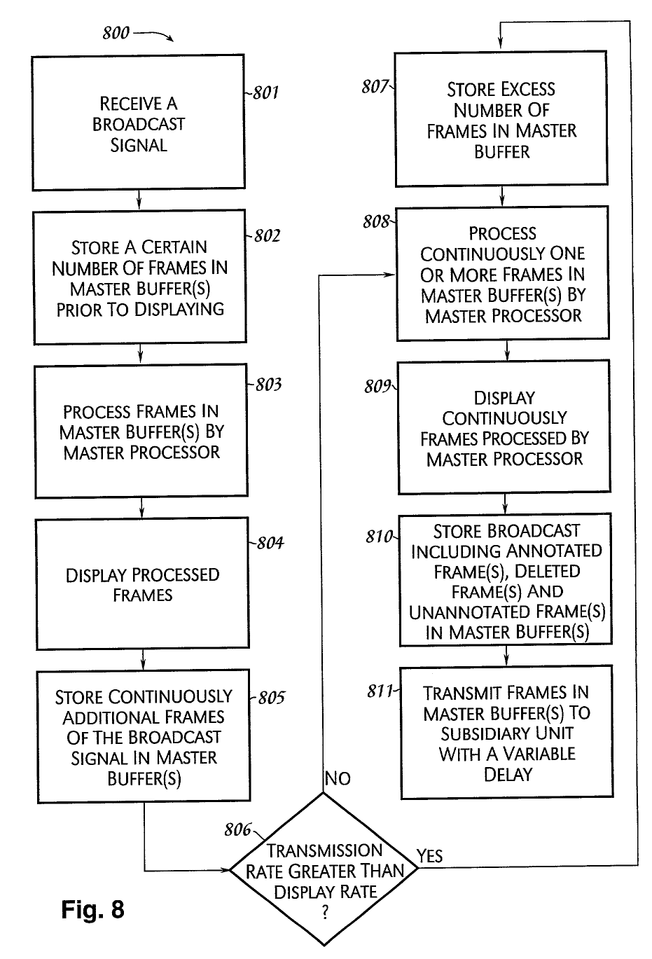

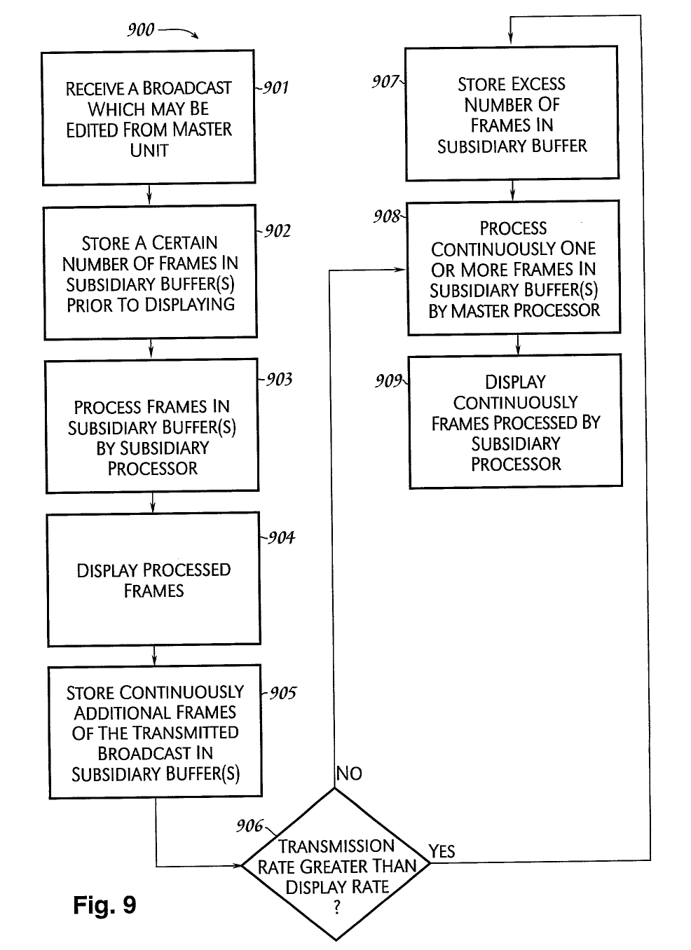

A diagram of the flow of broadcast information from information sources 307 (FIG. 3), e.g., broadcast networks 303, web sites 304, local affiliates 305, cable provider 306, to master unit 101 as well as from master unit 101, which may edit the broadcast, to one or more subsidiary units 102 is described further below. Furthermore, a flowchart of one embodiment of the present invention of a method for master unit 101 to receive a broadcast from information sources and transmit the broadcast, which may be edited, to one or more subsidiary units 102 is described in the description of FIG. 8. Furthermore, a flowchart of one embodiment of the present invention of a method for subsidiary unit 102 to receive a broadcast, which may be edited, from master unit 101 and to display that broadcast to a particular age group is described in the description of FIG. 9.

FIG. 7—Diagram Illustrating the Flow of Broadcast Information from a Transmitter to the Master Unit and then to a Subsidiary Unit

FIG. 7 illustrates a diagram of the flow of broadcast information from information sources 307 (FIG. 3), e.g., broadcast networks 303, web sites 304, local affiliates 305, cable provider 306, to master unit 101. Master unit 101 may then edit the broadcast which may be transmitted to one or more subsidiary units 102.

Referring to FIG. 7, transmitter, i.e., information sources 307, may transmit the broadcast at a faster or slower rate than the rate master unit 101 may display a broadcast. Upon receiving the broadcast, master unit 101 may be configured to store a certain number of frames in one or more buffers 103 in memory 214 prior to displaying the broadcast to a user, e.g., parent, teacher, guardian.

If the transmitting rate, e.g., 31 frames/second, exceeds the display rate, e.g., 30 frames/second, of master unit 101, master unit 101 may be configured to store the excess frames in one or more buffers 103 in memory 214. It is noted that even when the transmitting rate, e.g., 29 frames/second, is less than the display rate, e.g., 30 frames/second, of master unit 101, master unit 101 may be configured to continue to store additional frames to be processed and displayed in one or more buffers 103. Hence, even when the transmission rate, e.g., 29 frames/second, is less than the display rate, e.g., 30 frames/second, master unit 101 may not display an empty frame because of storing a certain number of frames in one or more buffers 103 in memory 214 prior to displaying the broadcast as well as continuing to store additional frames to be processed and displayed. That is, the displaying of the broadcast may be uninterrupted. When the information, i.e., frames of data, becomes near depletion in the one or more buffers 103 in memory 214, master unit 101 may be configured to request a retransmission from the transmitter, i.e., information sources 307.

As explained in the detail description of FIG. 4, master unit 101 may be configured to store a recorded broadcast that may be edited, e.g., frames may be deleted, verbal annotations may be interposed on the recorded broadcast. The edited broadcast may be stored in one or more buffers 103 that may be transmitted at a later time to one or more subsidiary units 102. For example, as each frame is recorded by master unit 101 without any edits to the frame, the frame may be saved in a particular buffer 103 that may then be transmitted to the appropriate one or more subsidiary units 102 within a particular delay, e.g., 2 seconds. Furthermore, if the frame has been annotated, the annotated frame may be saved in a particular buffer 103 that may then be transmitted to the appropriate one or more subsidiary units 102 within a particular delay, e.g., 2 seconds. However, if one or more frames have been deleted, then there may be a greater delay, e.g., 10 seconds, in the transmission of frame(s) to one or more subsidiary units 102 until there are frames with content to be transmitted. Hence, the edited broadcast may be transmitted to one or more subsidiary units 102 with a variable delay.

Referring to FIG. 7, master unit 101 may transmit the broadcast that may be edited to a subsidiary unit 102 at a faster or slower rate than the rate subsidiary unit 102 may display the broadcast. Upon receiving the broadcast that may be edited, subsidiary unit 102 may be configured to store a certain number of frames in one or more buffers 104 prior to displaying the broadcast to be viewed by a particular age group. If the transmitting rate, e.g., 31 frames/second, exceeds the display rate, e.g., 30 frames/second, of subsidiary unit 102, subsidiary unit 102 may be configured to store the excess frames in one or more buffers 104. It is noted that even when the transmitting rate, e.g., 29 frames/second, is less than the display rate, e.g., 30 frames/second, of subsidiary unit 102, subsidiary unit 102 may be configured to continue to store additional frames to be processed and displayed in one or more buffers 104. Hence, even when the transmission rate, e.g., 29 frames/second, is less than the display rate, e.g., 30 frames/second, subsidiary unit 102 may not display an empty frame because of storing a certain number of frames in one or more buffers 104 prior to displaying the broadcast as well as continuing to store additional frames to be processed and displayed.

FIG. 8—Method for a Master Unit to Receive a Broadcast and Transmit the Broadcast which may be Edited to a Subsidiary Unit

FIG. 8 illustrates a flowchart of one embodiment of the present invention of a method 800 for master unit 101 (FIG. 2) to receive a broadcast from information sources 307 (FIG. 3) and transmit the broadcast which may be edited to one or more subsidiary units 102 (FIG. 1).

Referring to FIG. 8, in step 801, master unit 101 may receive a broadcast signal transmitted by information sources 307. As described above, master unit 101 may store a certain number of frames in one or more buffers 103 (FIG. 1) in memory 214 (FIG. 2) prior to displaying the broadcast to a user, e.g., parent, teacher, guardian, in step 802. In step 803, master unit 101 may process one or more frames stored in the one or more buffers 103 in memory 214 by processor 210 (FIG. 2). In step 804, master unit 101 may display the one or more frames processed by processor 210 to display 238 (FIG. 2).

In step 805, master unit 101 may continuously store additional frames of the received broadcast signal in one or more buffers 103. A determination may then be made by master unit 101 in step 806 as to whether the transmission rate, i.e., the rate at which information sources 307 transmit the broadcast to master unit 101, is greater than the display rate of master unit 101. If the transmitting rate, e.g., 31 frames/second, exceeds the display rate, e.g., 30 frames/second, of master unit 101, master unit 101 may store the excess frames in one or more buffers 103 in memory 214 in step 807.

It is noted that even when the transmitting rate, e.g., 29 frames/second, is less than the display rate, e.g., 30 frames/second, of master unit 101, master unit 101 may be configured to continue to store additional frames to be processed and displayed in one or more buffers 103 in step 807. Hence, even when the transmission rate, e.g., 29 frames/second, is less than the display rate, e.g., 30 frames/second, master unit 101 may not display an empty frame because of storing a certain number of frames in one or more buffers 103 prior to displaying the broadcast as well as continuing to store additional frames to be processed and displayed. That is, the displaying of the broadcast may be uninterrupted. In one embodiment, when the information, i.e., frames of data, becomes near depletion in the one or more buffers 103 in memory 214, master unit 101 may be configured to request a retransmission from the transmitter, i.e., information sources 307.

In step 808, master unit 101 may continue to process one or more frames stored in the one or more buffers 103 in memory 214 by processor 210. In step 809, master unit 101 may continue to display the one or more frames processed by processor 210.

As explained in the detailed description of FIG. 4, master unit 101 may be configured to store a recorded broadcast that may be edited, e.g., frames may be deleted, verbal annotations may be interposed on the recorded broadcast, in step 810. The edited broadcast may be stored in one or more buffers 103 that may be transmitted at a later time to one or more subsidiary units 102 in step 811. For example, as each frame is recorded by master unit 101 without any edits to the frame, the frame may be saved in a particular buffer 103 that may then be transmitted to the appropriate one or more subsidiary units 102 within a particular delay, e.g., 2 seconds. Furthermore, if the frame has been annotated, the annotated frame may be saved in a particular buffer 103 that may then be transmitted to the appropriate one or more subsidiary units 102 within a particular delay, e.g., 2 seconds. However, if one or more frames have been deleted, then there may be a greater delay, e.g., 10 seconds, in the transmission of frame(s) to one or more subsidiary units 102 until there are frames with content to be transmitted. Hence, the edited broadcast may be transmitted to one or more subsidiary units 102 with a variable delay in step 811.

It is noted that method 800 may be executed in a different order presented and that the order presented in the discussion of FIG. 8 is illustrative. It is further noted that certain steps may be executed almost concurrently.

FIG. 9—Method for a Subsidiary Unit to Receive and Display a Broadcast, which may be Edited, Transmitted from the Master Unit

FIG. 9 illustrates a flowchart of one embodiment of the present invention of a method 900 for subsidiary unit 102 (FIG. 1) to receive a broadcast which may be edited from master unit 101 (FIG. 2) and to display that broadcast to a particular age group.

Referring to FIG. 9, in step 901, subsidiary unit 102 may receive a broadcast which may be edited from master unit 101. As described above, subsidiary unit 102 may store a certain number of frames in one or more buffers 104 (FIG. 1) prior to displaying the broadcast to a particular age group in step 902. In step 903, subsidiary unit 102 may process one or more frames stored in the one or more buffers 104 by a processor within subsidiary unit 102. In step 904, subsidiary unit 102 may display the one or more frames processed by the subsidiary processor.

In step 905, subsidiary unit 102 may continuously store additional frames of the received broadcast in one or more buffers 104. A determination may then be made by subsidiary unit 102 in step 906 as to whether the transmission rate, i.e., the rate at which master unit 101 transmits the broadcast which may be edited to subsidiary unit 102, is greater than the display rate of subsidiary unit 102. If the transmitting rate, e.g., 31 frames/second, exceeds the display rate, e.g., 30 frames/second, of subsidiary unit 102, subsidiary unit 102 may store the excess frames in one or more buffers 104 in step 907.

It is noted that even when the transmitting rate, e g., 29 frames/second, is less than the display rate, e.g., 30 frames/second, of subsidiary unit 102, subsidiary unit 102 may be configured to continue to store additional frames to be processed and displayed in one or more buffers 104 in step 907. Hence, even when the transmission rate, e.g., 29 frames/second, is less than the display rate, e.g., 30 frames/second, subsidiary unit 102 may not display an empty frame because of storing a certain number of frames in one or more buffers 104 prior to displaying the broadcast as well as continuing to store additional frames to be processed and displayed. That is, the displaying of the broadcast which may be edited may be uninterrupted.

In step 908, subsidiary unit 102 may continue to process one or more frames stored in the one or more buffers 104 by an internal processor. In step 909, subsidiary unit 102 may continue to display the one or more frames processed by the internal processor to a particular age group.

It is noted that method 900 may be executed in a different order presented and that the order presented in the discussion of FIG. 9 is illustrative. It is further noted that certain steps may be executed almost concurrently.

Although the system, computer program product and method are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for controlling the content of broadcast material comprising the steps of:
receiving a broadcast signal;
displaying a broadcast associated with said broadcast signal;
recording said broadcast;
assigning one or more sessions to said recorded broadcast;
associating one or more units with said one or more sessions;
editing said recorded broadcast for one or more of said one or more sessions; and
transmitting said edited broadcast to one or more of said one or more units associated with said one or more of said one or more sessions with a delay.

2. The method as recited in claim 1, wherein said step of editing said recorded broadcast for said one or more of said one or more sessions comprises the step of:
receiving input to delete content of said recorded broadcast associated with one or more sessions.

3. The method as recited in claim 1, wherein said step of editing said recorded broadcast for said one or more of said one or more sessions comprises the step of:
receiving input to annotate content of said recorded broadcast associated with one or more sessions.

4. The method as recited in claim 1, wherein each of said one or more units is configured to display said edited broadcast.

5. The method as recited in claim 1, wherein a first session of said one or more sessions is associated with a first edited recorded broadcast, wherein a second session of said one or more sessions is associated with a second edited recorded broadcast, wherein said first edited recorded broadcast is different in content from said second edited recorded broadcast.

6. The method as recited in claim 5, wherein said first edited recorded broadcast is edited for a first age group, wherein said second edited recorded broadcast is edited for a second age group.

7. The method as recited in claim 6, wherein said first edited recorded broadcast is transmitted to a first unit associated with said first session, wherein said first unit is configured to display said first edited recorded broadcast, wherein said second edited recorded broadcast is transmitted to a second unit associated with said second session, wherein said second unit is configured to display said second edited recorded broadcast.

8. The method as recited in claim 1, wherein said broadcast signal is stored in a memory buffer.

9. The method as recited in claim 1, wherein said delay is a variable delay.

10. The method as recited in claim 3, wherein said annotated contents are transmitted to said one or more of said one or more units associated with said one or more of said one or more sessions with said delay.

11. A computer program product embodied in a machine readable medium for controlling the content of broadcast material comprising the programming steps of:
receiving a broadcast signal;
displaying a broadcast associated with said broadcast signal;
recording said broadcast;
assigning one or more sessions to said recorded broadcast;
associating one or more units with said one or more sessions;
editing said recorded broadcast for one or more of said one or more sessions; and
transmitting said edited broadcast to one or more of said one or more units associated with said one or more of said one or more sessions with a delay.

12. The computer program product as recited in claim 11, wherein said programming step of editing said recorded broadcast for said one or more of said one or more sessions comprises the programming step of:
receiving input to delete content of said recorded broadcast associated with one or more sessions.

13. The computer program product as recited in claim 11, wherein said programming step of editing said recorded broadcast for said one or more of said one or more sessions comprises the programming step of:
receiving input to annotate content of said recorded broadcast associated with one or more sessions.

14. The computer program product as recited in claim 11, wherein each of said one or more units is configured to display said edited broadcast.

15. The computer program product as recited in claim 11, wherein a first session of said one or more sessions is associated with a first edited recorded broadcast, wherein a second session of said one or more sessions is associated with a second edited recorded broadcast, wherein said first edited recorded broadcast is different in content from said second edited recorded broadcast.

16. The computer program product as recited in claim 15, wherein said first edited recorded broadcast is edited for a first age group, wherein said second edited recorded broadcast is edited for a second age group.

17. The computer program product as recited in claim 16, wherein said first edited recorded broadcast is transmitted to a first unit associated with said first session, wherein said first unit is configured to display said first edited recorded broadcast, wherein said second edited recorded broadcast is transmitted to a second unit associated with said second session, wherein said second unit is configured to display said second edited recorded broadcast.

18. The computer program product as recited in claim 11, wherein said broadcast signal is stored in a memory buffer.

19. The computer program product as recited in claim 11, wherein said delay is a variable delay.

20. The computer program product as recited in claim 13, wherein said annotated contents are transmitted to said one or more of said one or more units associated with said one or more of said one or more sessions with said delay.

21. A system, comprising:
a memory unit operable for storing a computer program operable for controlling the content of broadcast material; and
a processor, responsive to said computer program, comprising:
circuitry operable for receiving a broadcast signal;
circuitry operable for displaying a broadcast associated with said broadcast signal;
circuitry operable for recording said broadcast;
circuitry operable for assigning one or more sessions to said recorded broadcast;
circuitry operable for associating one or more units with said one or more sessions;
circuitry operable for editing said recorded broadcast for one or more of said one or more sessions; and
circuitry operable for transmitting said edited broadcast to one or more of said one or more units associated with said one or more of said one or more sessions with a delay.

22. The system as recited in claim 21, wherein said circuitry operable for editing said recorded broadcast for said one or more of said one or more sessions comprises:
circuitry operable for receiving input to delete content of said recorded broadcast associated with one or more sessions.

23. The system as recited in claim 21, wherein said circuitry operable for editing said recorded broadcast for said one or more of said one or more sessions comprises:
circuitry operable for receiving input to annotate content of said recorded broadcast associated with one or more sessions.

24. The system as recited in claim 21, wherein each of said one or more units is configured to display said edited broadcast.

25. The system as recited in claim 21, wherein a first session of said one or more sessions is associated with a first edited recorded broadcast, wherein a second session of said one or more sessions is associated with a second edited recorded broadcast, wherein said first edited recorded broadcast is different in content from said second edited recorded broadcast.

26. The system as recited in claim 25, wherein said first edited recorded broadcast is edited for a first age group, wherein said second edited recorded broadcast is edited for a second age group.

27. The system as recited in claim 26, wherein said first edited recorded broadcast is transmitted to a first unit associated with said first session, wherein said first unit is configured to display said first edited recorded broadcast, wherein said second edited recorded broadcast is transmitted to a second unit associated with said second session, wherein said second unit is configured to display said second edited recorded broadcast.

28. The system as recited in claim 21, wherein said broadcast signal is stored in a memory buffer.

29. The system as recited in claim 21, wherein said delay is a variable delay.

30. The system as recited in claim 23, wherein said annotated contents are transmitted to said one or more of said one or more units associated with said one or more of said one or more sessions with said delay.
